(19) United States
(12) Patent Application Publication
(10) Pub. No.: US 2002/0093424 A1
(43) Pub. Date: Jul. 18, 2002

(54) Wireless multi-function communication device

(76) Inventor: Travis Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/765,123

(22) Filed: Jan. 17, 2001

(51) Int. Cl. G08B 1/08

(52) U.S. Cl. 340/539; 340/540

(57) ABSTRACT

A multi-function wireless communications device includes a personal telecommunications device in combination with a high frequency remote control device. The multi-function wireless communications device may include both remote control and wireless telecommunications functionality. A remote control circuit includes high frequency signal processing and remote control transmitter and receiver circuitry for providing a high frequency communication link between the multi-function wireless communications device and an appliance transceiver for communication with one or more appliances. A telecommunications circuit includes telecommunications signal processing and transmitter and receiver circuitry for providing a radio link between the multi-function wireless communications device and a telecommunications system.

### BACKGROUND OF THE INVENTION

1. Technical Field

The present invention relates generally to wireless communication devices and more particularly, to a multi-function wireless communication device.

2. Background Art

In a seemingly never-ending quest for smaller and more compact electronic and electronic control devices there has been a constant push to condense, combine and miniaturize components. Remote control devices according to the prior art may include the capability of selectively controlling one of a number of electronic or electronically controlled devices. Remote control devices are well known in the art for controlling electronic devices remotely via a device including an infrared (IR) transmitter that transmits information encoded onto an IR light beam to an IR receiver that is connected to or is integral with an electronic device. Additionally, remote control devices are well known in the art for selectively controlling more than one appliance. For example, a remote control device may be used to selectively control various functions of a television and a video cassette recorder (VCR).

Printers have been remotely controlled to the extent that a host computer is directly connected to a dedicated printer which operates in a normal printing mode and is operable by a cordless printer control device including a transmitter connected to a portable computer and a receiver connected to the dedicated printer. The transmitter and the receiver provide an infrared transmission link allowing the portable computer to access the dedicated printer for printing tasks.

### SUMMARY OF THE INVENTION

The present invention is directed to a multi-function wireless communication device capable of communication with one or more electronic devices including one or more appliances. The multi-function wireless communication device includes a remote control circuit including high frequency transmit and receive capability. The remote control circuit provides a high frequency communication link between the multi-function wireless communications device and an appliance control device including high frequency transmit and receive capability. The high frequency communication link may be maintained via infrared transmission or, in the alternative, via a radio frequency communication link including a short range radio link. The high frequency communication link may be switchable or ambient in the sense that if the wireless remote control is within the range of transmission between the appliance and the remote control the devices may communicate. The multi-function wireless communication device also includes control circuitry for controlling and switching operation between remote control and telecommunications functions. The multi-function wireless communication device also includes input circuitry for operating the various functions of the device and display circuitry for displaying various function and operations data.

An appliance may include any device having an appliance control circuit operable in response to the high frequency communication link between the remote control circuit and the appliance. The multi-function wireless communications device functions to transmit and receive data including appliance control data, appliance status data and appliance function data. One preferred embodiment of the multi-function wireless communications device includes a wireless remote printer control. The wireless remote printer control operates to control various control panel functions of a printing device including media selection, print job queuing, print job pause and continue and image resolution or density setting. Data representing printer function, system status and/or printer function command responses may be transmitted from the printer to the remote control.

The multi-function wireless communications device may include a telecommunications circuit in combination with the high frequency remote control circuit. The telecommunications circuit may be configured as a cellular or a radio frequency telecommunication device capable of transmitting and receiving communications data.

### BRIEF DESCRIPTION OF THE DRAWINGS

FIG. 1 is a schematic diagram depicting one embodiment of a multi-function wireless communications device according to the present invention; and

FIG. 2 is a block diagram of one embodiment of a multi-function wireless communications device according to the present invention.

### DETAILED DESCRIPTION OF THE INVENTION

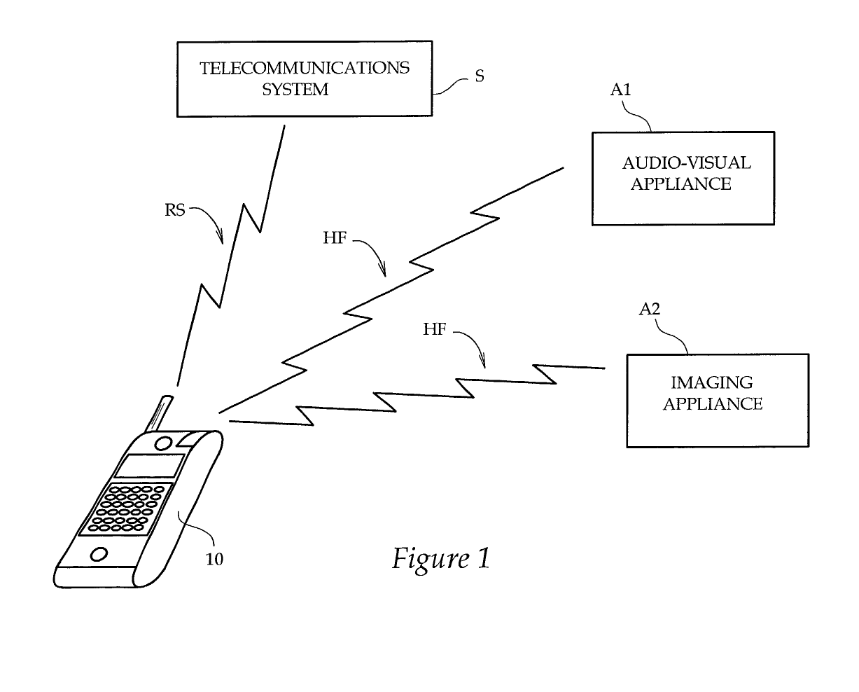

Referring to FIG. 1, multi-function wireless communications device 10 is capable of functioning in a wireless remote capacity with audio-visual appliance A1 as well as imaging appliance A2 via high frequency communication links HF. Additionally, multi-function wireless communications device 10 is capable of functioning in a telecommunications capacity with telecommunications system S via radio signal RS.

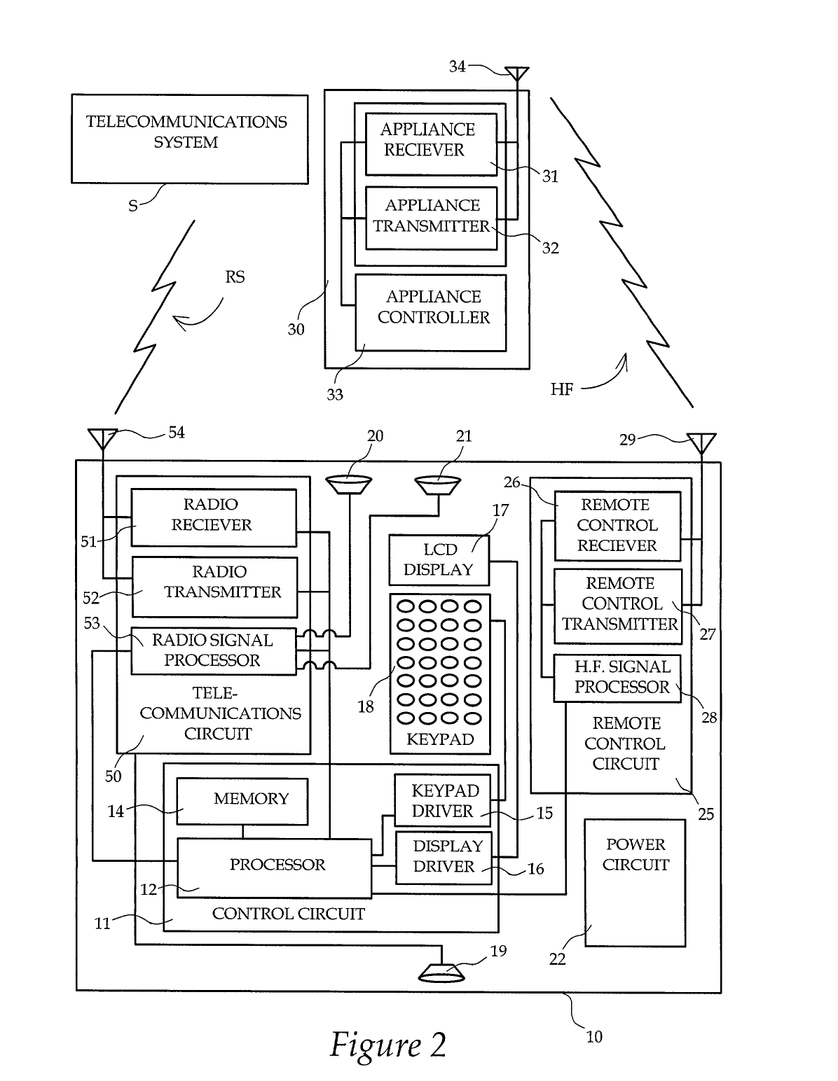

FIG. 2 is a block diagram showing multi-function wireless communications device 10 communicating with appliance 30 via high frequency communication links HF and with telecommunications system S via radio signal RS. Multi-function wireless communications device 10 including control circuit 11, remote control circuit 25 and telecommunications circuit 50. Control circuit 11 includes processor 12 and memory 14 connected to processor 12. Control circuit 11 enables various remote control and telecommunication functions including switching between remote control and telecommunication functions, selection of data transmission protocol or mode for both remote control circuit 25 and telecommunications circuit 50. Processor 12 controls operation of remote control circuit 25 and telecommunications circuit 50 in accordance with control program and control data stored in memory 14. Processor 12 may respond to entries on key pad 18 to enable switching between remote control and telecommunications functions. Display driver 14 and keypad driver 15 are also connected to processor 12. LCD display 17 and keypad 18 are connected to display driver 16 and keypad driver 15 respectively. LCD display 17 displays circuit status and function data for both remote control circuit 25 and telecommunications circuit 50. LCD display 17 may also display telecommunications data and information both received and for transmission. Keypad 18 provides for input of data for both remote control circuit 25 and telecommunications circuit 50.

Input transducer 19 provides means for audio input to multi-function wireless communications device 10. Output transducer 20 provides means for audio output from multi-function wireless communications device 10. Ringer transducer 21 signals incoming radio signal. Power supply circuit 22 supplies required operation voltage for control circuit 11, remote control circuit 25 and telecommunications circuit 50.

FIG. 2 shows remote control circuit 25 including remote control receiver circuit 26 and remote control transmitter circuit 27 and H.F. signal processor 28 as known generally in the prior art. Remote control receiver circuit 26 and remote control transmitter circuit 27 are connected to remote control antenna 29 and control circuit 11 through H.F. signal processor 28. Remote control circuit 25 may be configured either for infrared or short wave radio transmission and reception.

FIG. 2 also shows telecommunications circuit 50 including radio receiver circuit 51 and radio transmitter circuit 52 connected to radio signal processor circuit 53 and antenna 54. Radio circuit 51 transmits and receives radio signal RS using analog modulation and demodulation. Radio signal processor circuit 53 includes baseband, signal compression, signal expansion, signal filtering and synthesis and control signal circuitry. Radio circuit 51 is connected to control circuit 11 which controls the operation telecommunications circuit 50 in accordance with a telecommunications control program and control data stored in memory 14. Control circuit 11 enables various telecommunication functions including dialing, call initiation and call termination.

FIG. 2 shows appliance 30 including appliance receiver circuit 31 and appliance transmitter circuit 32 connected to appliance antenna 34 and appliance controller 33. Appliance controller 33 monitors and controls various appliance functions, operation parameters and components in accordance with signals received by appliance receiver circuit 31 from remote control circuit 25. For example, in the event that appliance 30 comprises a printer, appliance controller 33 would comprise a printer controller. In the event that appliance 30 comprises a television, appliance controller 33 would comprise an audio-visual controller. In the event that a radio signal is received by radio receiver 51 indicating an incoming call, telecommunications circuit 50 may signal control circuit 11 of the incoming call. In the event that appliance 30 comprises a television or other audio device, appliance controller 33 may be signaled or programmed to signal, by operation of remote control circuit 25, appliance controller 33 to effect a muting signal.

While this invention has been described with reference to the detailed embodiments, this is not meant to be construed in a limiting sense. Various modifications to the described embodiments, as well as additional embodiments of the invention, will be apparent to persons skilled in the art upon reference to this description. It is therefore contemplated that the appended claims will cover any such modifications or embodiments as fall within the true scope of the invention.

What is claimed is:

1. A multi-function wireless communications device comprising:
a control circuit;
an input device connected to the control circuit;
a display device connected to the control circuit;
a remote control circuit connected to the control circuit; and
a telecommunications circuit connected to the control circuit.

2. The multi-appliance remote control of claim 1 wherein the remote control circuit further comprises:
a remote control high frequency transmitter circuit connected to the control circuit and connectable to an appliance control circuit by a high frequency communication link; and
a remote control high frequency receiver circuit connected to the control circuit and connectable to the appliance control circuit by the high frequency communication link; and
a remote control high frequency signal processor connected to the remote control transmitter circuit, remote control receiver circuit and the control circuit.

3. The multi-appliance remote control of claim 1 wherein the telecommunications circuit further comprises:
a radio transmitter circuit connected to the control circuit and connectable to a telecommunications system by a radio signal;
a radio receiver circuit connected to the control circuit and connectable to the telecommunications system by the radio signal; and
a radio signal processor circuit connected to the radio transmitter circuit, the radio receiver circuit and the control circuit.

4. The multi-appliance remote control of claim 1 wherein the input device further comprises a keypad.

5. The multi-appliance remote control of claim 1 wherein the display further comprises an LCD display.

6. The multi-appliance remote control of claim 1 wherein the control circuit further comprises a switch for switching operation of the multi-function wireless communications device between the remote control circuit and the telecommunications circuit.

7. A multi-function wireless communications device comprising:
a control circuit including;
a processing device; and
a storage medium connected to the processing device;
a remote control circuit connected to the control circuit including;
a remote control transmitter circuit connected to the control circuit and connectable to an appliance control circuit by a high frequency communication link;
a remote control receiver circuit connected to the control circuit and connectable to an appliance control circuit by a high frequency communication link; and
a remote control high frequency signal processor connected to the remote control transmitter circuit, the remote control receiver circuit and the control circuit; and
a telecommunications circuit connected to the control circuit including;
a radio transmitter circuit connected to the control circuit and connectable to a telecommunications system by a radio signal;
a radio receiver circuit connected to the control circuit and connectable to the telecommunications system by a radio signal; and
a radio signal processor circuit connected to the radio transmitter circuit, the radio receiver circuit and the control circuit.

8. The multi-appliance remote control of claim 7 wherein the input device further comprises a keypad.

9. The multi-appliance remote control of claim 7 wherein the display further comprises an LCD display.

10. The multi-appliance remote control of claim 6 wherein the control circuit further comprises a switch circuit for switching operation of the multi-function wireless communications device between the remote control circuit and the telecommunications circuit.
